(19) United States
(12) Patent Application Publication
(10) Pub. No.: US 2002/0107718 A1
(43) Pub. Date: Aug. 8, 2002

(54) "Host vendor driven multi-vendor search system for dynamic market preference tracking"

(76) Inventors: Mark N. Morrill, St. Albert, CA (US); John C. Davis, Edmonton (CA)

Correspondence Address: SHERIDAN ROSS PC, 1560 BROADWAY, SUITE 1200, DENVER, CO, 80202

(21) Appl. No.: 09/777,429

(22) Filed: Feb. 6, 2001

(51) Int. Cl. G06F 17/60

(52) U.S. Cl. 705/10

(57) ABSTRACT

A vendor hosts a search interface and method for managing multiple networked vendors accepts a search query and performs a meta-search for matching content. The search results are indexed and displayed. When the consumer makes a preferred selection, the preference is tracked and the consumer is redirected to the URL for the selected content, regardless of whether the content is provide by the host vendor, thereby maintaining consumer loyalty despite their selection from a competing vendor. Specifically, the consumers search request is formatted into a specific format and posted to an array of search engines. The search results are parsed and information is extracted, indexed and displayed as a custom HTML formatted list, A sub-selection of information is identified for obtaining real-time market preferences.

### FIELD OF THE INVENTION

The present invention relates to a system for a host vendor server searching multiple vendors for content using each vendors own search processes and redirecting a client browser to the selected content. More specifically, databases of multimedia content are searched, consumers are redirected to a specific vendor's content for their preferred selection, and market preferences for specific selected content are recorded.

### BACKGROUND OF THE INVENTION

Computers are often used to search and access information from large databases. Commonly, text search engines are used to search and access textual data using text queries with logical operations applied to the text. There are many systems in the prior art that perform these text-searching functions.

Most recently, computers have been used to store, search and access multimedia documents from multimedia databases. Multimedia is information that may contain text, still images, audio, video, 3D and/or any other type of sensory information. Digital imagery is one or more digital records of images, either still or moving, that are typically viewed with a computer and stored in a database. The information in this database can have multiple aspects, that is, one or more of the records can contain one or more data types including text, images, video, animation, audio, and various three-dimensional formats.

Different types of search engines have been developed in the prior art to handle different types of content. Typically, images in a multimedia database are searched and accessed using an image search engine. An image search engine works by referencing a database in which a set of corresponding features are applied to and stored for each image that is indexed. In response to a query, which is expressed in terms of the features of the desired images, the search engine searches the database for sets of features that best match the query. The result is a list of images which correspond to the sought features images.

Conventional search engines of this sort include QBIC and PictureBook. See Niblack, W., Barber, R., Equitz, W., Flickner, M., Glasman, E., Petkovic, D., Yanker, P., Faloutsos, C., and Taubin, G., “The QBIC project: querying images by content using color, texture, and shape”, proceedings SPIE-International Society of Optical Engineering (USA) Volume 1908, 1993, pages 173-187 and also Pentland, Alexander P., Picard, Rosalind W., and Sclaroff, Stan, “Photobook: Tools for content-based manipulation of image databases”, Proceedings of SPIE—The International Society for Optical Engineering, Volume 2368, 1995, pages 37-50. Both of these references are herein incorporated by reference in their entirety.

In addition to textual and image searching, the prior art contains search engines that search on parameters, or attributes. Parametric search engines generally function with tables of data, in which each row in the table represents an object and the column represents parametric data associated with the object. An example of such data could include author, title, and date. Known parametric search engines include the IBM Database2 (or DB2) relational system (IBM and DB2 are trademarks of the International Business Machines Corporation).

New technologies, like the Internet, give consumers, through their client browser, access to a significant amount of information, often in the form of multimedia documents, consisting of text, images, sound and video clips. In many search engine systems, each digital image can have associated with it such parametric data including keywords, style, color, background, emotion, theme, genre, etc. Consumers who wish to find relevant images need to be able to specify keywords directed to this content (e.g., that the text contains the word “moon” and at least one image, e.g. a picture of the “full moon”) or to the parametric data (for example, black and white not color.) Searching for particular information in digital image databases, especially over networks such as the Internet or the World Wide Web (WWW), is still a labor intensive and formidable task. Meta-search engines are now available which somewhat simplify the process by engaging and utilizing a plurality of other site's own search engines to collect search results, eliminate duplicates and present the results in an integrated format.

To avoid the large overhead associated with searching millions of sites across the network in real time, the known search engines typically prepare their own pre-indexed and updated databases of site addresses and content, only several of which may be commercial sites which contain the content sought by the searcher. The consumer's review of this vast amount of data is a daunting and discouraging task, particularly to the specific commercial content consumer.

Using conventional searching methodology, a professional user of high-resolution images who is trying to find one or more commercial still images, for purchase, must search the entire Internet for all images in all web pages with a sequence of queries. That search generally produces a massive volume of search results which very possibly have no relevance at all to the user's desire to purchase a high-resolution image, whether rights-protected or royalty free. Further, once the consumer locates a vendor site, the consumer is generally required to issue a separate query for each media type at each vendor's web site and there is no known method for narrowing a web search to only e-commerce offerings.

In another aspect, particularly relevant to a e-commerce site vendor, a consumer using a meta-search engine may select content from the search results which comes from a competitor's site and the vendor will remain unaware of several key factors: why did the consumer choose the competitor's content, and if it was because the vendor did not provide comparable content, what was the nature of the content. For example, the vendor would ideally wish to learn that the consumer was seeking images of airplanes with clouds in the background, yet the vendor did not provide such content in their site's database. Further, it is timely to note that various regulatory authorities are determining whether and to what extent such consumer online profiling may be accomplished, and by minimizing intrusions of a consumer's online privacy. To date, e-commerce profiling has been to include electronic identifiers of the consumer, examples including consumer computer-resident cookies or tracing of the user's internet address. There is a noted sensitivity and increasing resistance by consumers.

Accordingly, there is a need for a system and method that obtains a single query, identifies one or more media types, and searches multiple collections of content across specified, yet multiple, vendor's e-commerce Internet sites containing digital imagery (multimedia) so as to return a single combined results list.

Further, as the operator of such an e-commerce site, it is desirable to be able to track the market's choices of such multimedia, and if the consumers opted to choose another vendor's content, then to ascertain why. Ideally, the above can be accomplished with minimal intrusion on the consumer's privacy.

### SUMMARY OF THE INVENTION

The present invention provides a host vendor system and method of use which provides a consumer with access to a variety of commercial products and which overcomes the disadvantages of sequentially searching numerous commercial sites to find their desired e-commerce offerings. The invention enables consumer to search related vendors' offerings through a single site. The specific results are compiled, indexed and displayed to the consumer. Once the consumer makes a selection, the consumer is directed to the URL for the selected content, being located at the vendor's site, whether it be that of the host or a third party's site for finalizing the e-commerce transaction. Further, using the present invention, if the final selection is from a competing site, the lost sale is not a complete loss for the host vendor. Instead, information regarding the consumer's preference is recorded so that the host vendor can assess deficiencies in their product database and content offerings.

In a preferred form, a consumer submits a single query, with one or more media types, to search an offered collection of e-commerce databases and to produce a single compiled list of the search results of the database content. The e-commerce databases include the host vendor's offerings and at least one third party offering. The ultimate combined search results is crafted to conform to specific user requirements by applying general logical operations to the results of the search results for each of the search engines. When a search result is selected, two processes take place: first, preference information regarding the selection is stored and secondly the consumer is re-directed to the vendor's site for processing the transaction.

In a broad aspect of the invention, a host vendor system for conducting e-commerce at a plurality of sites including the host vendor site is provided comprising:

receiving a search request from a client;

searching the content of each of the host vendor and the one or more third party vendors for the search request;

receiving search results from each of the host and third party vendors;

extracting information including at least an identification of the content and locator addresses for each of the search results;

displaying the search results to the client and receiving a client's preferred selection therefrom;

storing information which distinguishes the preferred selection from the balance of the search results; and

redirecting the client using the extracted locator address for the preferred selection.

Preferably, the search can be media sensitive and the content is multimedia. More preferably, should the preferred selection be from a third party vendor, the distinguishing information is applied to adapt the host vendor's content for future search requests.

### BRIEF DESCRIPTION OF THE DRAWINGS

FIG. 1 is a flowchart of the method for implementing a conventional single vendor internet commerce site;

FIG. 2 is a flowchart illustrating one embodiment of the method of the present invention for the presentation of multiple vendor's goods and making a sale or for adapting to a lost sale;

FIGS. 3-6 are a graphical flowchart representation of the client browser viewpoint of one embodiment of the present invention;

FIG. 3 is a flowchart illustrating search initiation including selection of two or more vendors, formation of a search strategy, and adaptation of the query string for submission to the two or more vendors;

FIG. 4 is a flowchart continued from FIG. 3 which illustrates parsing of the search results and subsequent indexing and storage in a database;

FIG. 5 is a flowchart continued from FIG. 4 which illustrates a browser window which displays a summary list of the search results, indexed to the host vendor's indexed database;

FIG. 6 is a flowchart continued from FIG. 5 which illustrates redirection of the consumer to the selected vendor's site for finalizing the e-commerce transaction;

FIGS. 7-10 are flowcharts which illustrate the contributions and interactions between the host vendor's server, the client browser and the third party vendors server for implementing the process set forth in FIGS. 3-6;

FIG. 7 illustrates the steps for initiating a session through returning html search results from each search engine;

FIG. 8 is a flowchart continued from FIG. 7 which illustrates parsing of the html through selection of the preferred results;

FIG. 9 is a flowchart continued from FIG. 8 which illustrates redirection to the selected vendor's site and recordation of the selection information; and

FIG. 10 is a flowchart continued from FIG. 9 which illustrates the adaptation of the host vendor's content in reflex to the market preference.

### DETAILED DESCRIPTION OF THE PREFERRED EMBODIMENT

While the preferred embodiment is described in terms of image media, the specific content offered or sold through the various vendor sites is understood to be any commercial product. Examples of such various possible content include images, video, audio, compact discs, literature and simply any product which is available from a variety of competing vendors. Further, there is no limitation on the product's ability to be rendered in an electronic or downloadable form. Vendors need merely to provide a catalog or database as an index to the product which can be subsequently provided or shipped to the consumer.

In the described embodiment, a consumer is seeking a specific product such as an image which can be utilized in an advertising project. Due to copyright restrictions and the changing marketplace, the consumer is seeking to purchase current and commercial images which can be used under license without risk of copyright violation and which may best meet their objectives. One form of licensed image use is known as a royalty-free license. A royalty-free image can be purchased for a flat, one-time fee and permits non-exclusive yet unlimited use of the image in the purchaser's own media. Such images are now commonly and typically provided through e-commerce vendor sites, assessed through a network such as the Internet.

State of the Art

The Internet interconnects a multitude of client's computers and servers for the presentation and exchange of digital data. A server typically hosts a “web site” which transmits graphical Web pages of information to a remote client computer system. The remote client computer system can then display the pages in a window. Each page is uniquely identifiable by a Uniform Resource Locator (“URL”) or address. Either a client computer system specifies the URL directly, or a hypertext link in the current page places a Hypertext Transfer Protocol (“HTTP”) request for the display of another page.

The page itself comprises a plurality of instructions for directing a browser program, on the client's computer, how to display and structure the page. These instructions, or tags, are written in a Hypertext Markup Language (“HTML”). An HTML structured page can also include references or URL's of other pages.

The World Wide Web is especially conducive to conducting electronic commerce. Many Web servers have been developed through which vendors can advertise and sell products, descriptions and information for which are stored as content in database. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. The items in the catalog are provided as content listed in one or more databases which are accessible through a search interface or search engine.

A search engine is typically provided as an HTML page interface which displays a list or summary of pre-compiled and continually updated database, options for searching the database and provides an appropriate search query dialog. A consumer, who is a potential purchaser can enter one or more keywords into the query dialog and receive back search results. The database contains content which could have been gleaned or data mined from the entire internet.

As a first objective, the present invention seeks avoid a common problem with conventional WWW search engines which return volumes of material which may be dated or can have weak correlation with the user's objectives.

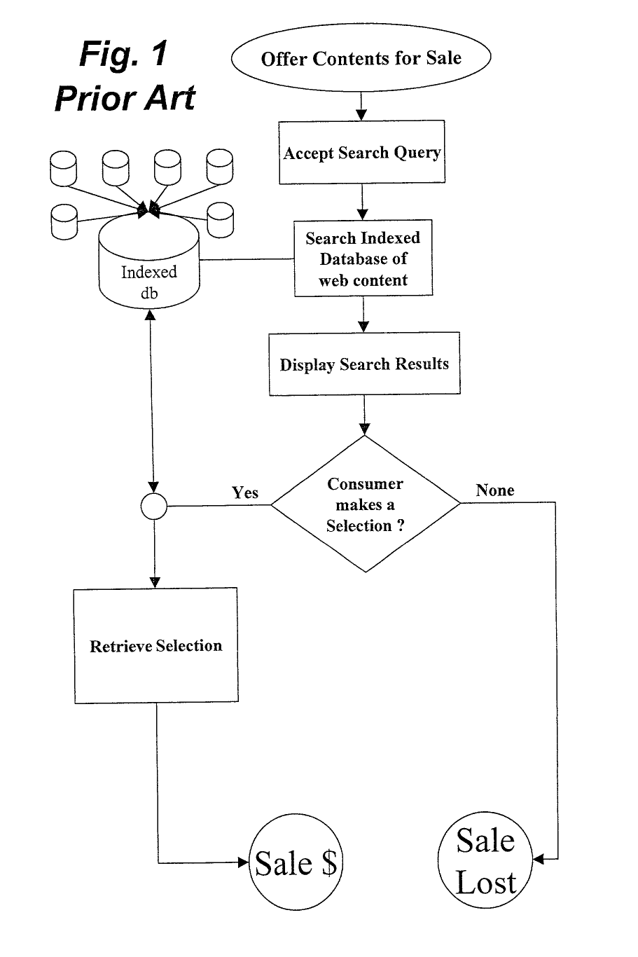

Referring to FIG. 1, as shown in the prior art process, when a consumer seeks to purchase an item from an online catalogue database, the consumer accesses the vendor's site. The consumer utilizes a client computer and a network such as the Internet to access the vendor's site comprising a server. The server provides a page to the consumer which includes a search interface and a query dialog for searching the network for specified content.

The consumer enters a search query. The site engine accepts the query, applies it to its indexed database of other's sites and returns search results. The database is being constantly updated with new material from other databases. The search results, if any, are displayed as URL links in a new page or a replacement page. If the consumer is pleased with one of the results, the consumer selects the associated link, the selection is retrieved from the database and engages the appropriate e-commerce task. This can include the well known shopping cart and checkout models or scenarios. if the consumer does not see a suitable match, they may re-submit a modified search or leave the site and no sale is made.

In this prior art process, if the consumer leaves the site, the vendor receives no insight or explanation for the lost sale.

Further, if a specific media was being specifically sought, such as an image then, if any images were returned at all, they are often neither commercial, nor are they copyright infringement-free or royalty-free. The consumer is then forced to go to successive commercial sites and input their search parameters time and time again. In the case of conventional meta-search engines, even if a suitable hit was made, and a suitable link was returned, the search engines direct the consumer to the vendor's main web page or site. The consumer then must re-enter the search query so as to re-select the desired image from all the vendor's offerings.

First Embodiment

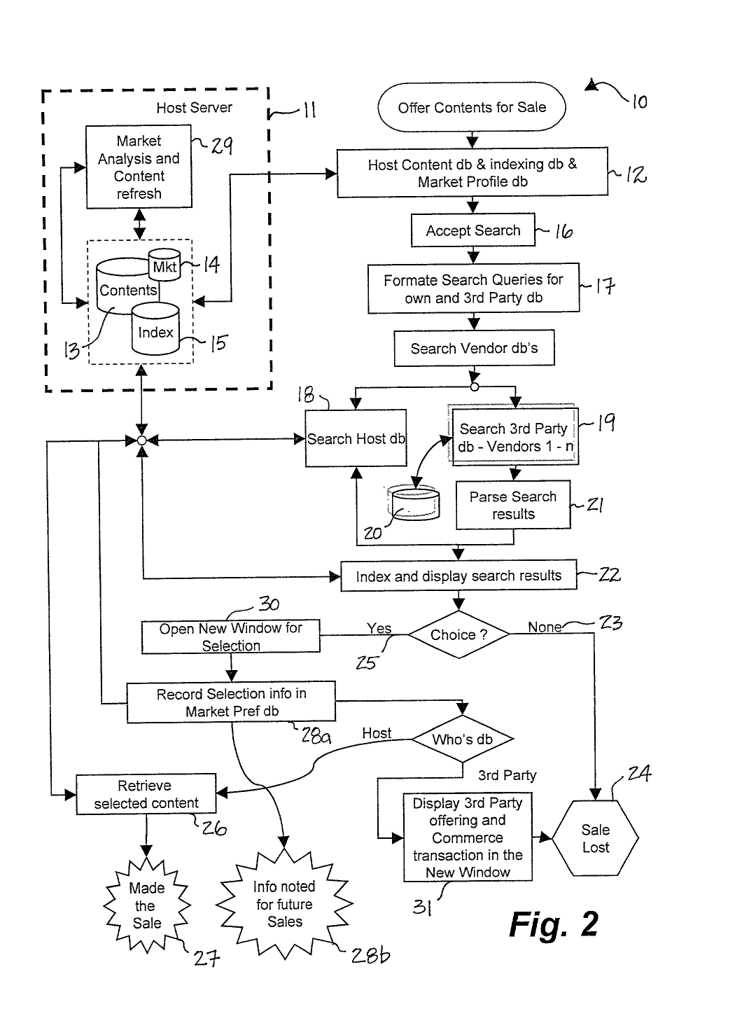

The method of the present invention, as shown generally in FIG. 2, utilizes a primary or host vendor site 10 which utilizes a search interface to access their own and third party (3^{rd}P) vendor's content, a search results indexing engine and database, and means for presenting to the consumer a commerce transaction for their preferred selection regardless of which vendor's offering was selected. If the offering was not the host vendor's content, then a unique process determines the market preferences for future and dynamic adaptation of the host vendor's content. Accordingly, even if a sale is ultimately lost to another vendor, sufficient information is recorded for enabling further study to determine why the consumer went elsewhere and provide the background to enable the hosing vendor to assess whether this preferred selection or content is from a market in which they wish to compete and, if so, what specific additional or revised content should be added to their offerings.

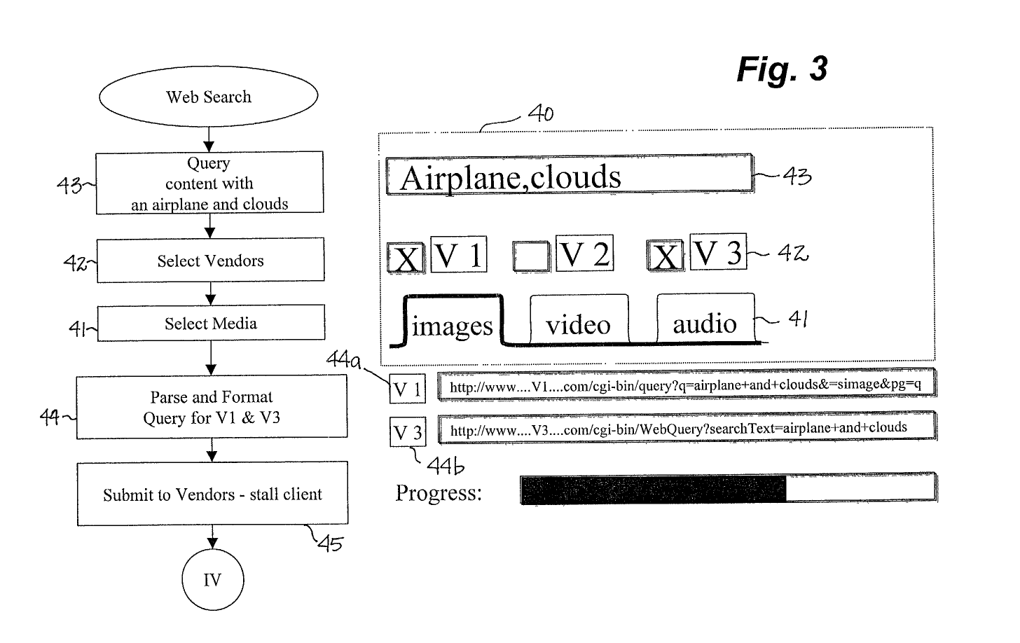

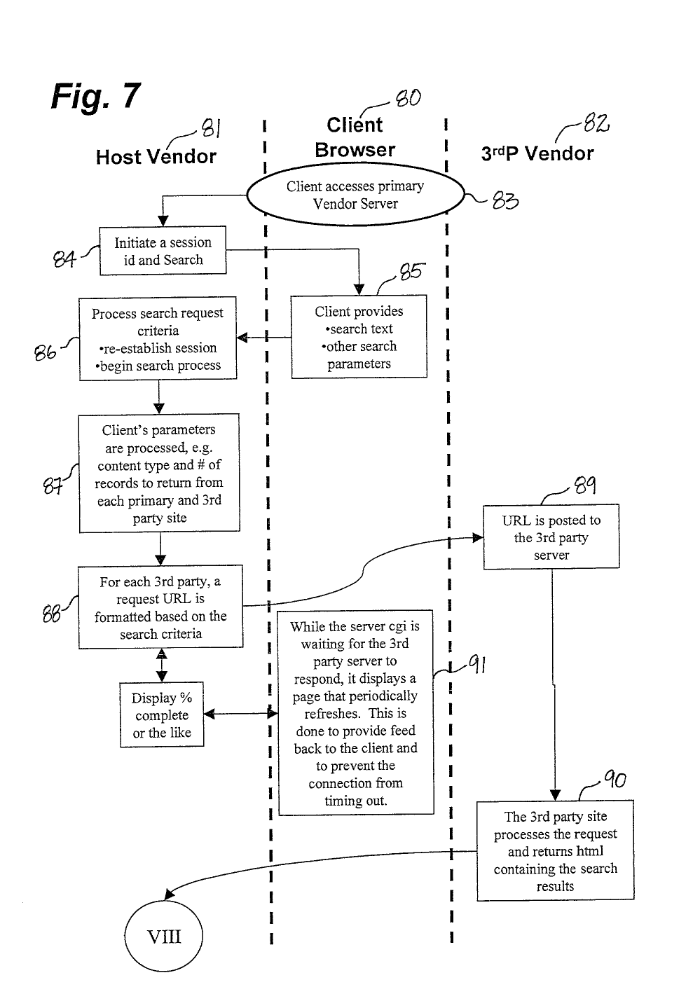

FIG. 2 provides a simplified overview of one embodiment of the invention. FIGS. 3-6 illustrate one diagrammatic form of the browser interface and display. FIGS. 7-10 illustrate the various relationships of the network.

Having reference to FIGS. 2 and 3-6, the host vendor 10 comprises a server 11 running a host management program, script or process. One such scripting language is known as the Common Gateway Interface or CGI. One of several known programming or scripting languages can be used to support a CGI process. Processes using this approach can typically be identified by a /cgi-bin/ directory reference in their URL. The host server further comprises a searching interface 12, primary content database 13, a market preference database 14 and an indexing engine which maintains an indexed database 15 of the search results.

The host process displays a page to the client computer which provides a search query interface and accepts a search query 16 from the consumer.

The query is formatted 17 for posting to search 18 the host vendor's database 13 and to search 19 one or more 3^{rd}P vendor's sites and content databases 20. The additional 3^{rd}P databases 20 are accessible through the network.

The search query is a character string which is formulated into a format compatible for submission to the process searching the host vendor's primary database 13 and for submission 19 to the 3^{rd}P vendor's site's. The search string is formulated into one or more query URL strings which are compatible with the 3^{rd}P vendor's sites own search and retrieval processes. A plurality of thread processes proceed to post the individual search URL to the 3^{rd}P vendor sites.

Search results are returned to the host vendor's process. Typically, the results are returned as an HTML page which, in prior art processes, would be displayed at the consumer's browser. Instead, the host vendor's process parses 21 the HTML pages for extraction of significant information including locator addresses or URL links to the search results.

The host vendor's process compiles the search results of content from all databases and indexes 22 them for relational lookup and retrieval on the host server. The indexed search results are displayed as an HTML page to the consumer.

At this point, if the consumer makes no selection 23, then one may assume that the client was not satisfied with any of the search results and a sale will not result 24, either for the host vendor or a 3^{rd}P vendor.

In one embodiment, the extracted information includes: a no-sale status, the search parameters, the search results keywords, or the keyword associated with each returned search result, all of which can be forwarded to the market preferences database as an indication of a shortcoming in the host and third party vendor database content.

In a further embodiment, and more significantly, the consumer will makes a selection 25. in the host vendor's perfect world, the consumer makes a selection from the search results corresponding to the host vendor's offerings. The host vendor simply retrieves 26 the selected content and makes the sale 27. Sometimes however, the consumer selects the 3^{rd}P vendor's offering. In the prior art, the sale would merely be lost with no lessons learned.

In contradistinction to the prior art, the present invention satisfies two objectives: the first being to introduce an intermediate step which enables a recording 28a, 28b of the consumer's selection preference for enabling implementation of a dynamic adjustment 29 of the scope of the host vendor's product offering in the future; and the second being to open 30 a new window and redirect 31 the consumer directly to the 3^{rd}P vendor's site as if the consumer had made the product selection at that vendor's site and thus is not required to re-submit the query. This instills a consumer loyalty in the host vendor's site, whether or not the consumer has recently purchased the host vendor's offerings.

The consumer is therefore provided with one-stop shopping of multiple vendor's sites and further, if the host vendor missed the sale, information is recorded to enable the host vendor to assess the lost opportunity and make an informed decision whether to adapt their content or ignore such specific requests in the future.

Having reference to FIG. 3, more specifically, the method of the invention provides an a HTML page 40 having a combined query interface enabling selection of media type 41, preferred vendor 42 and search parameters 43. A consumer selects one or more of the listed vendor sites V1-V3 and inputs a single query which can be directed to more than one media/data type by selecting one of the media type tabs. As illustrated, one query 43 can be directed to content containing both an airplane and clouds. In the illustrated case, the preferred content is images and in this case, the consumer selected Vendor V1 and V3.

The combined query has a query data structure 44 which is submitted to the query interface of the host server CGI process (V1). The query interface stores the different parts of the query and then parses the query to separate and format the query according to type. A query object is built for each query type (e.g. still image, video clip, audio, etc). The query interface translates and formats each of the query objects by query-type into queries that are interpreted by the application programming interfaces (API's) that are designed for a particular search engine. As shown in FIG. 3, the query string 44a for Vendor V1 (http://www . . . ) can be quite distinct from the query string 44b formatted for Vendor V3. The process then distributes or submits the queries 45 to the appropriate search engines. Due to certain limitations with HTML processes, it can be a requirement to continually refresh the connection with the client computer.

The search of each query type is performed by the appropriate search engine local to the e-commerce vendor V1-V3 and each vendor's search engine returns results that are converted to a collection of search results objects.

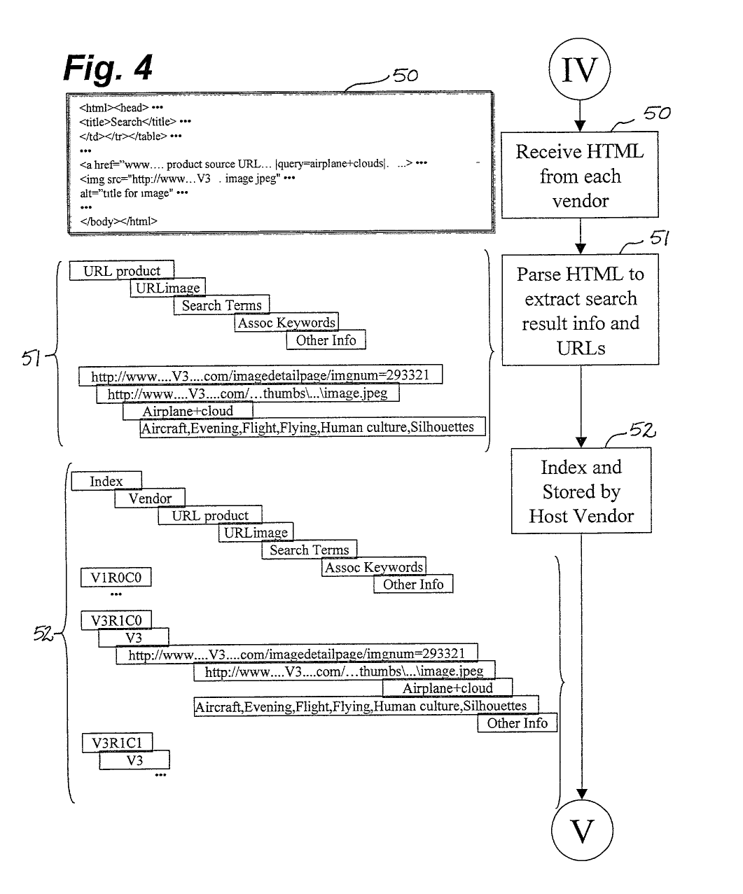

Having reference to FIG. 4, each result object comprises a data type of information: vendor, product (an image) URL location, image URL and database number, search terms used to locate the image, image name, associated key words, a media type, and any other information.

The global result is then passed to a mixer. The mixer is a collection of one or more algorithms that operates on the global result object to produce a single result list. These algorithms have algorithm parameters. Both the algorithms and the parameters are user selected and allow a consumer to choose requirements to which the results have to conform. For example, one of the algorithms can have one or more arbitrary logical operations and/or ranking. The single result list has entries that are based on the user requirements. All of this takes place in an HTML document 50 to present the HTML results to the consumer's client browser.

From the HTML results, a parsing process 51 locates the information which is stored as records and assigned an index number 52 for lookup at the host vendor. One simple format 53 is to reference the eventual summarized HTML output format such as assigning numbers for the Vendor, the row and the column where the content is displayed.

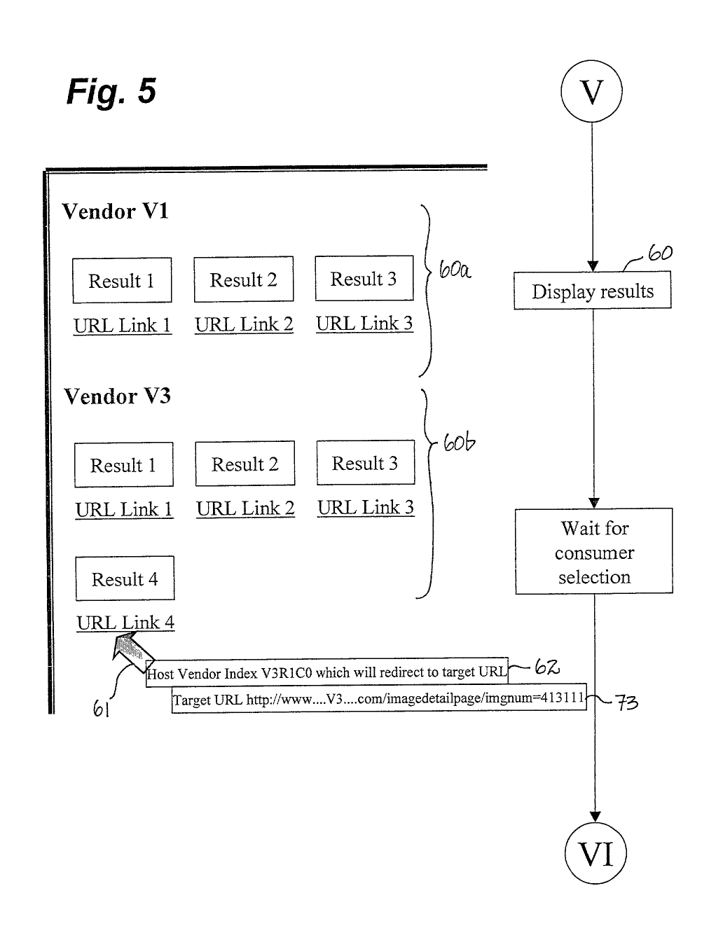

Having reference to FIG. 5, a sample HTML output page 60 displays three qualifying results 60a from the host vendor V1, and four results 60b from a 3^{rd}P vendor V3. A pointer 61 for the browser is illustrated as being directed at the 3^{rd}P vendor's V3 fourth-located offering. Once selected, if this was the preferred selection from the search results, then the process looks up the indexed results V3R1C0 62 at the host vendor.

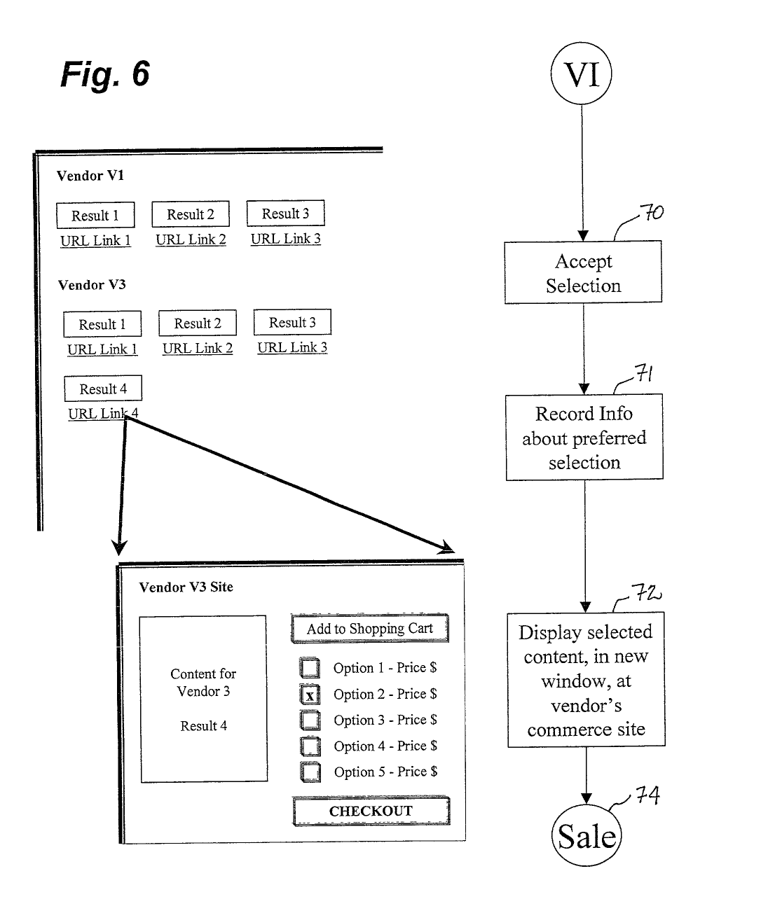

As shown in FIG. 6, the consumer's selection is accepted 70 and a subselection of stored Information about the record is recorded 71 by the host vendor. Once the information is recorded, the consumer is redirected to the 3^{rd}P vendor's content 72 at locator address 73 (URL Link 4 at FIG. 5) so that the consumer can complete the transaction 74, most importantly, without having to repeat the search that provided them with the preferred selection.

Turning to FIGS. 7-10, the mechanics of the above process are provided in greater detail and with emphasis on the geography of the process. As described, processes occur at each of three main sites: the consumer's client browser 80, the host vendor 81, and the one or more 3^{rd}P vendors 82.

Referring to FIG. 7, the process begins with the consumer requesting content 83. A session id is established and the host vendor cgi process initiates a search 84. The host vendor presents a search interface to the consumer who provides the search query and parameters 85. The query is returned to the host vendor for processing 86. The search query is processed for search parameters 87 such as identifying which vendors to search, numbers of records to return (which is possible to specify with some vendors). The host vendor formats search queries for the selected 3^{rd}P vendors 88. The host vendor posts the formatted query to the 3^{rd}P vendor server 89. The 3^{rd}P site processes and returns the results in HTML 90. While the 3^{rd}P vendor sites are processing the search, the host vendor performs a periodic refresh 91 of the client browser to ensure the session doesn't expire.

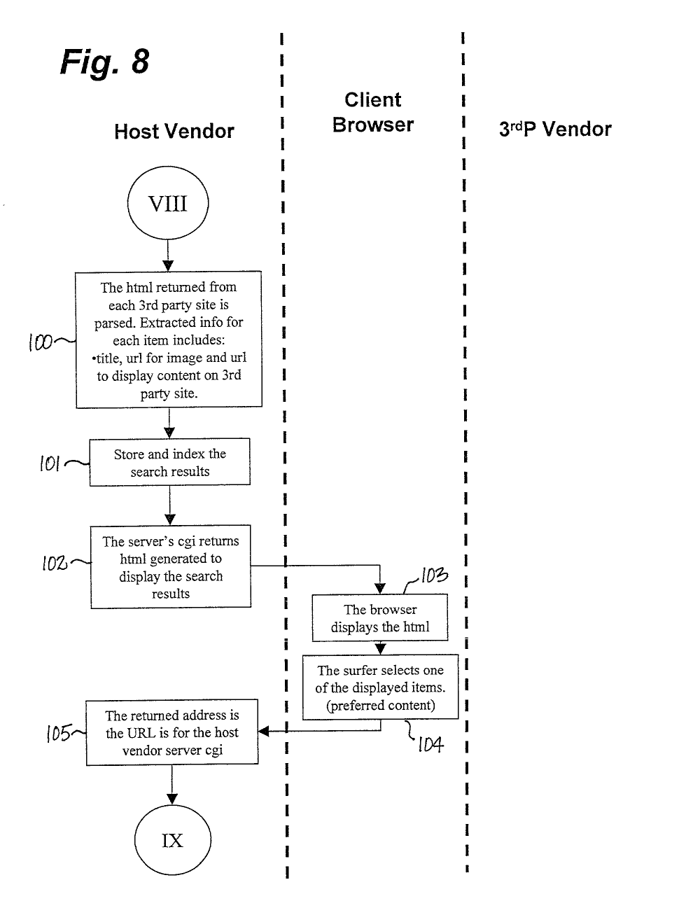

At FIG. 8, the 3^{rd}P HTML results are parsed by the host vendor 100 for extracting the information. The information is stored and indexed by the host vendor 101. The search results are placed in HTML summary format 102 which is displayed 103 at the client browser. The consumer makes their selection by selecting their preferred content 104 and the associated index URL is returned 105 to the host vendor process.

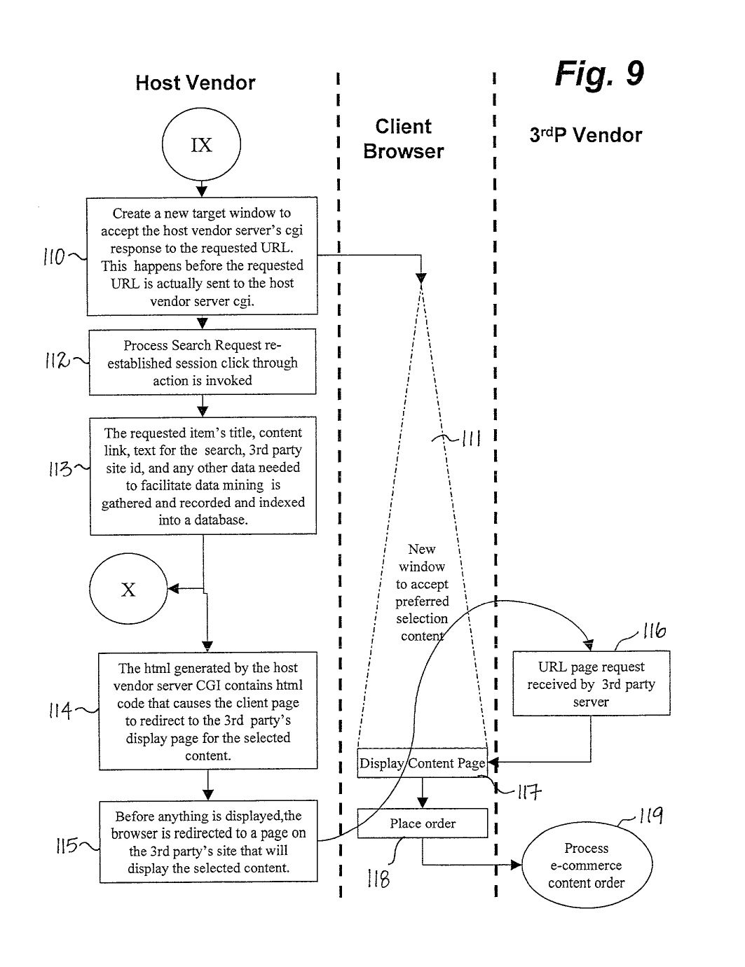

Referring to FIG. 9, the host vendor processes the URL and its associated information stored in its index record. The process creates 110 a new window 111 for displaying the consumer's preferred selection and the session is reestablished 112. Information about the preferred selection is gathered 113 and stored in the market preference database 14, including a flag that a 3^{rd}P offering was selected over the host vendor's offering.

In a step which maintains business efficacy and consumer loyalty, the host vendor generates HTML code 114 so that the consumer is conveniently and seamlessly redirected 115 to the URL for the preferred selection, even if it is for the 3^{rd}P vendor. The appearance to the consumer is that their client browser is redirected from the host vendor's search interface page and to a sublevel 116 at the 3^{rd}P vendor's site. The resulting page display for the consumer 117 is the results page for the specified and preferred selection. At this point the consumer can place an order 118 and complete a commerce transaction 119 using a shopping cart, or checkout model as is provided at the selected vendor's site.

In the case where the consumer selected a 3^{rd}P vendor's offering, there is an opportunity for the host vendor to be proactive and choose to adapt their content for the future.

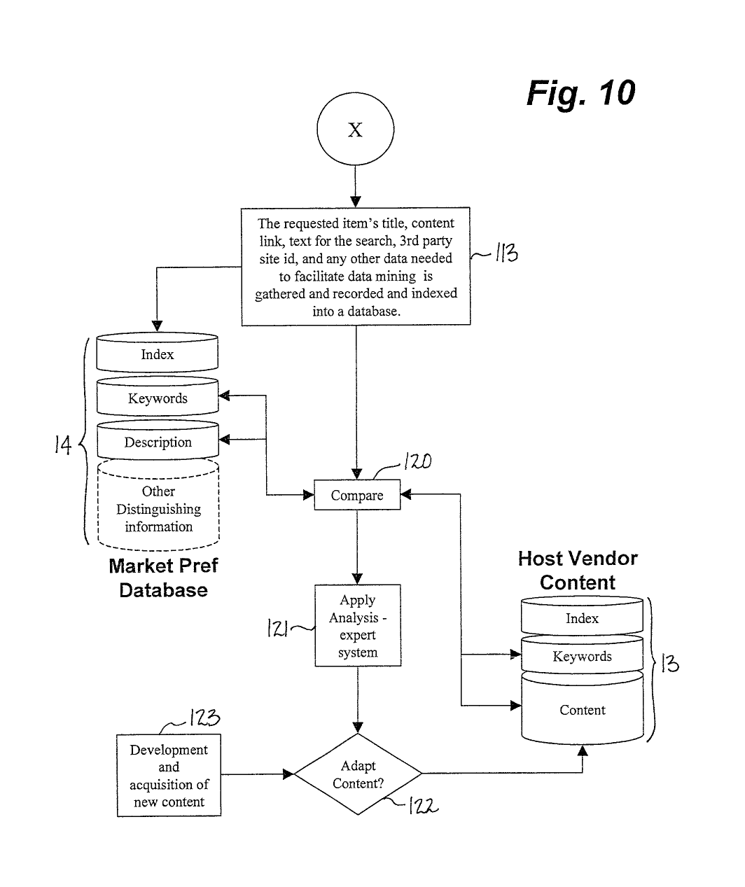

Having reference to FIG. 10, in one embodiment, the host vendor processes the recorded information in the market database 14 relating to the preferred selection and compares 120 it with their current content 13. In some cases the sale could have been lost merely because the keywords identifying the content were not extensive enough or were inappropriate. In other cases, the preferred content was not available. Expert systems, fuzzy logic and statistical analyses, and rules can be applied to analyse 121 the need to adapt, whether to adapt their content 122 at all, an employ means to invoke an adaptation. The host vendor can work to develop or acquire new content 123 as indicated by the analysis and update their content accordingly.

The embodiments of the invention in which an exclusive property or privilege is claimed are defined as follows:

1. A method for managing client access to content offered by a hosting vendor and one or more third party vendors across a network, the method comprising:
(a) receiving a search request from a client;
(b) searching the content of each of the host vendor and the one or more third party vendors for the search request;
(c) receiving search results from each of the host and third party vendors;
(d) extracting information including at least an identification of the content and locator addresses for each of the search results;
(e) displaying the search results to the client and receiving a client's preferred selection therefrom;
(f) storing information which distinguishes the preferred selection from the balance of the search results; and
(g) redirecting the client using the extracted locator address for the preferred selection.

2. The method of claim 1 further comprising displaying a search interface to the client from which the search request is received.

3. The method of claim 2 wherein the content is multimedia content.

4. The method of claim 3 further comprising:
obtaining a preferred media type from the search interface;
determining the media type from the extracted information; and
arranging the displayed search results according to the media type.

5. The method of claim 4 further comprising establishing from the extracted and stored information additional multimedia content which could be added to the host vendor's content so as to improve the likelihood of a client selecting the host vendor over the one or more third party vendors.

6. A host vendor system comprising:
a search interface which applies a search query to content offered by the host vendor and by one or more third party vendors and which produces search results;
an indexing process which extracts and indexes information including content description and locator addresses for each of the search results,
a display process which displays the search results and accepts an action signaling a preferred selection;
a recording process which records unique extracted information distinguishing the preferred selection from the balance of the search results; and
a redirection process which displays search results corresponding to the indexed content locator address for the preferred selection.

7. The host vendor system of claim 6 further comprising an updating process for adapting the host vendor's content to better represent the preferred selection.

8. A method for determining market preference between a host vendor and one or more competing third party vendors of like content comprising:
submitting a search query of keywords to the host vendor;
directing the search query from the host vendor to each of the third party vendors for determining search results of content for the host vendor and the one or more third party vendors;
formatting the search results of content by the host vendor and displaying a compilation thereof indexed by vendor and a locator address for each search result;
monitoring the compilation by the host vendor for selection of a locator address for a preferred content;
identifying the keywords and the vendor associated with the selected preferred content so that the preferred vendor, locator address and preferred content is identified.

9. The method of claim 8 further comprising adapting the host vendors content to include the preferred content.
